(19) United States
(12) Patent Application Publication
(10) Pub. No.: US 2020/0085017 A1
(43) Pub. Date: Mar. 19, 2020

(54) Self Leading Leash

(71) Applicant: Heather Ann Gregson, Everett, MA (US)

(72) Inventor: Heather Ann Gregson, Everett, MA (US)

(21) Appl. No.: 16/131,196

(22) Filed: Sep. 14, 2018

(51) Int. Cl. A01K 27/00

(52) U.S. Cl. CPC A01K 27/003; A01K 27/002; A01K 27/001

(57) ABSTRACT

The Self Leading Leash consists of a tether terminating at a grip suitable to be held in an animal's mouth wherein the opposite end is clipped, tied, hooked, or otherwise fixed to an animal collar or harness, or leash or lead that is commonly used to restrain or check an animal

### FIELD OF INVENTION

The Self Leading Leash is intended to appease an animal while under the control of a human by leash or lead. Many animals relate a leash to an activity or place that they enjoy, a walk or destination, and eagerly accept being bound to a leash. The animal's enthusiasm is sometimes displayed in the act of holding the leash handle in its mouth as if walking itself. By providing a second lead with a grip that can be held in the animal's mouth the animal can gain a sense of doing it itself without the human relinquishing control over the animal.

### BACKGROUND

The animal lead or leash has been in use for hundreds of years. As civilization increased, the animal has become largely domesticated. Cities routinely implement laws with regard to animals that are among the public, commonly referred to as leash laws. These laws are primarily directed toward the domestic dog. While a leash can be attached to any animal, it is the dog that provides the greatest implementation of leashes. While leashes are regularly revised, within the experience of this inventor there has been no known implementation of a leash for the purpose of allowing the dog to believe it is in control of itself. It is thereby believed that the Self Leading Leash is an original implementation of the common leash. While the Self Leading Leash can be attached to any leash, lead, harness or collar that is used in any capacity to control any animal that is controllable by a leash or lead, it is the intention of this inventor that the Self Leading Leash be primarily applied to the domestic dog.

### DRAWINGS

Figure one demonstrates possible configurations of the Self Leading Leash, but is not intended to represent the only configurations.

While the image indicates the most common and likely elements of the Self Leading Leash it is understood that any of the connecting ends can be paired with any of the grips or with other connectors and grips that are not depicted.

FIG. 1

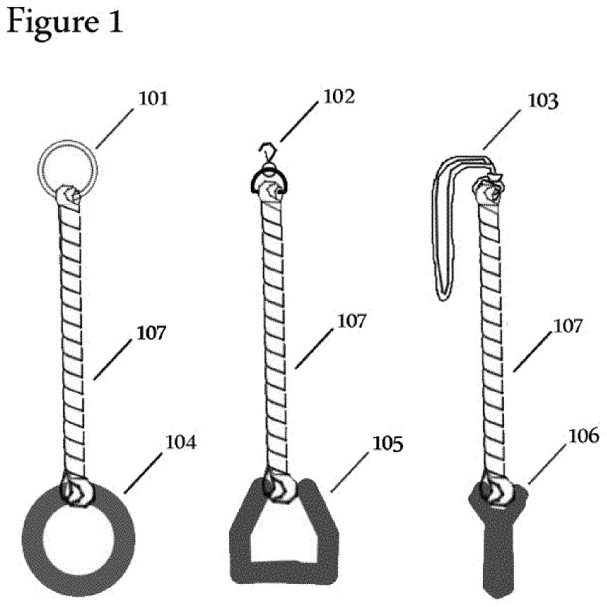

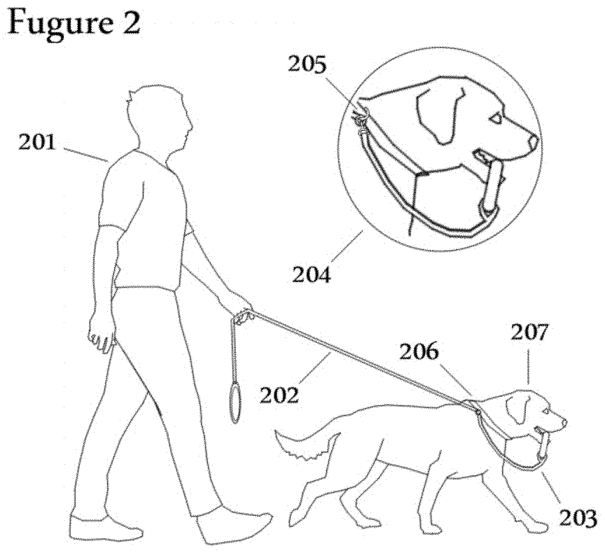

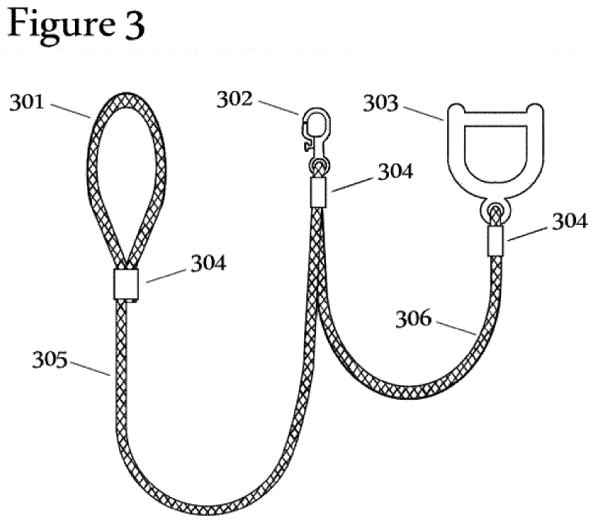

101—A ring of a material suited to retain the tether by slipping it around a leash or lead or by clipping it to a leash, lead, collar or harness or to their connecting hardware.

102—A hook or clip suited to retain the tether by hooking or clipping it to a leash, lead, collar or harness or to their connecting hardware.

103—A tie suited to retain the tether by tying it by knot, or looping it around or through itself and the leash or lead or their connecting hardware.

104—A ring suited to being held in the mouth of an animal without causing harm to the animal.

105—Encircled lengths suited to being held in the mouth of an animal without causing harm to the animal.

106—A single length suited to being held in the mouth of an animal without causing harm to the animal.

107—A tether suited to retaining attached connectors and grips at opposing ends.

1

Figure two depicts a dog using a Self Leading Leash while being controlled by a leash that is held by a man.

FIG. 2

201—A man walking a dog.

202—A common leash.

203—The Self Leading Leash in use by a dog.

204—An inset of a dog's head and the Self Leading Leash with its grip being held in the dog's mouth.

205—A junction of connections for the Self Leading Leash, the common leash and a collar.

206—A collar.

207—A dog head.

2

Figure three shows an example of a common leash and the Self Leading Leash and how they might be constructed as one piece.

FIG. 3

301—A handle for a common leash.

302—A unified connection which attaches the leash and the Self Leading Leash to a collar or harness.

303—A grip suited to being held in the mouth of an animal.

304—A method of binding two sections of a tether.

305—A tether that might be used for a common leash.

306—A tether that might be used for the Self Leading Leash.

### SUMMARY

The Self Leading Leash consists of a length of tether (107, 305, 306), that might be of any material commonly used in the production of animal leads and leashes, that at one end is fixed to a grip which is intended to be held within an animal's mouth (104, 105, 106, 303) while the opposite end is fixed to hardware or a utility (101, 102, 103, 205) that can be connected to a leash, collar or harness (206) that has been employed to control the animal. The grip, although not limited to, might be of a shape like a ring (104) or encircled lengths (105) or a single length (106), and of a material which might be held in the animal's mouth (204) without harm to the animal's mouth or teeth. The other end of the Self Leading Leash might connect by ring (101) or hook (102, 302) or by tie (103) or by another means that can secure the Self Leading Leash to a harness or collar or leash that is to be worn by an animal. Another connection method might be by manufacture wherein the Self Leading Leash could be a permanent part (304) of a leash or lead (FIG. 3) produced for the purpose of controlling an animal. For the purpose of this document, grip is to mean; any device suited to being held in an animal's mouth: and connector, connection, and connected are to mean; any method that secures something to another thing.

1. The inventor of the Self Leading Leash claims the sole rights to a line, rope, tether, chain, or strap that terminates at one end to any connection to or for a line, rope, tether, chain, strap or straps that would generally be regarded as a collar, a harness, a lead or a leash, and with the other end terminating in any manner or at any device where the end or the device can be held in the mouth of an animal.
